(19) United States
(12) Patent Application Publication
(10) Pub. No.: US 2007/0152962 A1
(43) Pub. Date: Jul. 5, 2007

(54) User interface system and method

(75) Inventors: Sang-youn Kim, Seoul (KR); Kyu-yong Kim, Yongin-si (KR); Byung-seok Soh, Suwon-si (KR); Gyung-hye Yang, Seoul (KR); Yong-beom Lee, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/509,611

(22) Filed: Aug. 25, 2006

(30) Foreign Application Priority Data
Jan. 2, 2006 (KR) 10-2006-0000216

(51) Int. Cl. G09G 5/00

(52) U.S. Cl. 345/156

(57) ABSTRACT

A user interface system and method for providing a vibration signal are provided. The user interface system includes a storage module to store a plurality of graphic objects and attribute information of each of the graphic objects, a control module to receive motion information of an interface object moved a user among the plurality of graphic objects from an interface device and to provide frequency information and amplitude information based on the motion information and the attribute information, and a drive module to generate a vibration signal based on the frequency information and the amplitude information and to transmit the vibration signal to the interface device.

### CROSS-REFERENCE TO RELATED APPLICATION

This application is based on and claims priority from Korean Patent Application No. 10-2006-0000216 filed on Jan. 2, 2006, in the Korean Intellectual Property Office, the disclosure of which is incorporated herein in its entirety by reference.

### BACKGROUND OF THE INVENTION

1. Field of the Invention

The present invention relates to user interface, and more particularly, to a user interface system and method for generating a vibration signal that can be easily recognized by a user based on motion information of a graphic object and information on a surface of another graphic object existing on a graphic screen when the user operates the object on the graphic screen using a user interface device and transmitting the vibration signal to the user interface device, thereby increasing an operation feeling with respect to the user interface device.

2. Description of the Related Art

With the development of technology, various types of user interface devices have been developed to operate a graphic object displayed on a two- or three-dimensional graphic screen. A vibration motor is an example of a user interface device.

In conventional technology, just attribute information (e.g., surface information such as a rough surface, a smooth surface, or a soft surface) regarding a graphic object displayed on a graphic screen is transferred to a user through a user interface device, but attributes of another graphic object are not provided to a user as tactual information considering the motion of the graphic object directly operated by the user.

For example, a feeling of bumping into a thing having a certain stiffness at a speed of 1 m/sec is different from a feeling of bumping into a thing having the same stiffness at a speed of 10 m/sec. Accordingly, a method of generating a vibration signal based on motion information of a graphic object operated by a user on a graphic screen and information on another object existing on the graphic screen and transmitting the vibration signal to the user is desired.

### SUMMARY OF THE INVENTION

Additional aspects and/or advantages of the invention will be set forth in part in the description which follows and, in part, will be apparent from the description, or may be learned by practice of the invention.

The present invention provides a method and system for generating a vibration signal that can be easily recognized by a user based on motion information of a graphic object operated by the user on a graphic screen and information on a surface of another graphic object.

The present invention also provides a method and system for transmitting the vibration signal to the user through a user interface device.

These and other objects of the present invention will be described in or be apparent from the following description of the preferred embodiments.

According to an aspect of the present invention, there is provided a user interface system including a storage module storing a plurality of graphic objects and attribute information of each of the graphic objects, a control module receiving motion information of an interface object representing a user among the plurality of graphic objects from an interface device and providing frequency information and amplitude information based on the motion information and the attribute information, and a drive module generating a vibration signal based on the frequency information and the amplitude information and transmitting the vibration signal to the interface device.

According to another aspect of the present invention, there is provided a user interface method including receiving motion information of an interface object representing a user among a plurality of graphic objects from an interface device, providing frequency information and amplitude information based on the motion information and attribute information of each of the graphic, generating a vibration signal based on the frequency information and the amplitude information, and transmitting the vibration signal to the interface device.

According to another aspect of the present invention, there is provided a user interface method including receiving motion information of an interface object moved by a user among a plurality of graphic objects from an interface device, providing frequency information and amplitude information based on the motion information and attribute information of each of the graphic, generating a vibration signal based on the frequency information and the amplitude information, and transmitting the vibration signal to the interface device.

According to still another aspect of the present invention, there is provided a user interface system including a display screen displaying a plurality of graphic objects and an interface object representing a user among the plurality of graphic objects, and an input unit for operating a moving speed of the interface object, wherein vibration is transmitted to the input unit according to the moving speed and surface information of a graphic object interacting with the interface object.

### BRIEF DESCRIPTION OF THE DRAWINGS

The above and/or other features and advantages of the present invention will become more apparent by describing in detail embodiments thereof with reference to the attached drawings in which:

FIG. 1 is a block diagram of a user interface system according to an embodiment of the present invention;

FIG. 2 is a block diagram of a control module included in a host device, according to an embodiment of the present invention;

FIG. 3 is a block diagram of a drive module included in a host device, according to an embodiment of the present invention;

FIG. 4 is a flowchart of a user interface method according to an embodiment of the present invention;

FIG. 5 illustrates a game device according to an embodiment of the present invention;

FIG. 6 is a block diagram illustrating the structure of a game device according to an embodiment of the present invention;

FIG. 7 illustrates the amplitude of tactual information in an embodiment of the present invention;

FIG. 8 illustrates a virtual block according to an embodiment of the present invention;

FIG. 9 illustrates a user interface system according to another embodiment of the present invention; and

FIG. 10 illustrates a user interface system according to still another embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

The present invention is described hereinafter with reference to flowchart illustrations of user interfaces, methods, and computer program products according to embodiments of the invention. It will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks.

These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Each block of the flowchart illustrations may represent a module, segment, or portion of code, which comprises one or more executable instructions for implementing the specified logical function(s). It should also be noted that in some alternative implementations, the functions noted in the blocks may occur in a different order. For example, two blocks shown in succession may in fact be executed substantially concurrently or the blocks may sometimes be executed in the reverse order, depending upon the functionality involved.

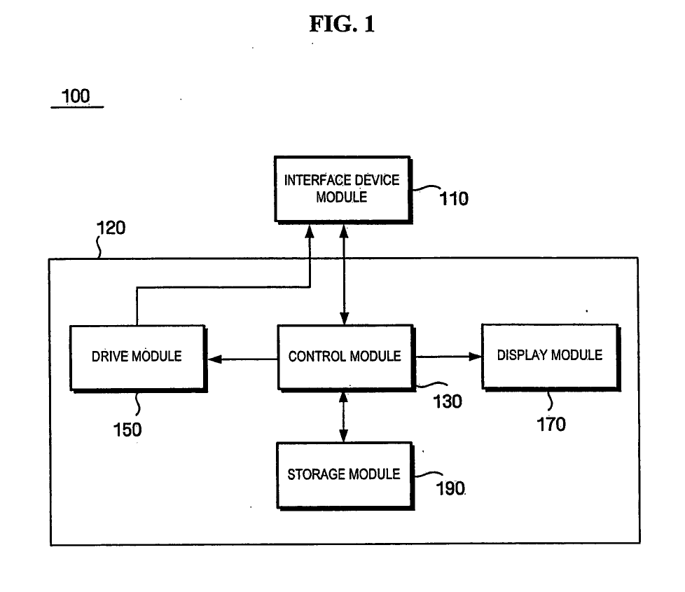

FIG. 1 is a block diagram of a user interface system 100 according to an embodiment of the present invention.

Referring to FIG. 1, the user interface system 100 according to an embodiment of the present invention includes an interface device module 110, which contacts a user's body and is operated by the user; and a host device 120, which moves a graphic object according to the user's operation input through the interface device module 110, converts surface information of another graphic object into a vibration signal with respect to a motion of the graphic object, and provides the vibration signal to the interface device module 110.

The host device 120 includes a control module 130, a drive module 150, a display module 170, and a storage module 190.

The term ‘module’, as used herein, means, but is not limited to, a software or hardware component, such as a Field Programmable Gate Array (FPGA) or Application Specific Integrated Circuit (ASIC), which performs certain tasks. A module may advantageously be configured to reside on the addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules.

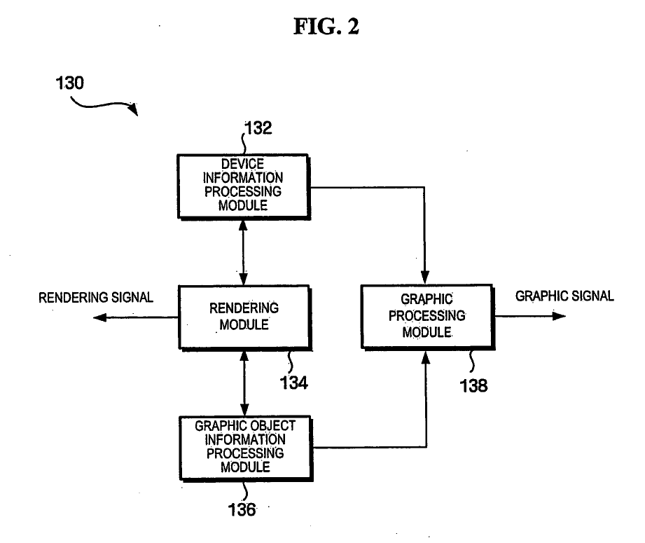

The control module 130 outputs a graphic screen and graphic objects through the display module 170 and controls a motion of a graphic object moving according to user operation information received from a user through the interface device module 110. Hereinafter, a graphic object that moves according to the user operation information and indicates the user's position on a graphic screen is referred to as an “interface object” and is distinguished from other graphic objects on the graphic screen. The detailed structure of the control module 130 will be described with reference to FIG. 2 later.

The storage module 190 stores information on various graphic screens and graphic objects displayed through the display module 170 and particularly stores attribute information of each of the graphic objects.

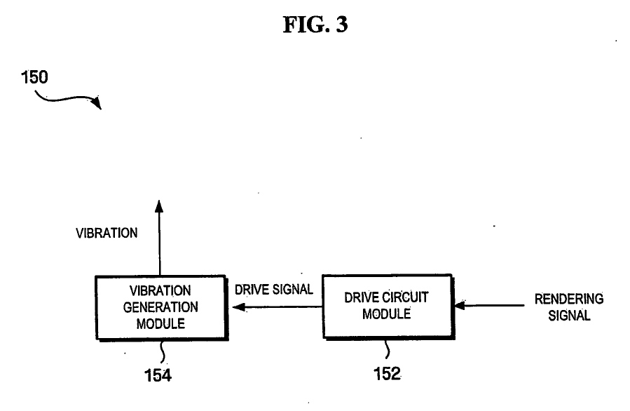

The drive module 150 receives attribute information of a graphic object corresponding to a result of interaction between the interface object and the graphic object from the control module 130, converts the attribute information into a vibration signal, and provides the vibration signal to the interface device module 110. The detailed structure of the drive module 150 will be described with reference to FIG. 3 later.

The operation of the user interface system 100 will be described with an assumption that a graphic screen and graphic objects stored in the storage module 190 are displayed through the display module 170 of the host device 120 and one object among the displayed graphic object is an interface object.

The graphic objects include a two- or three-dimensional graphic object and each of the graphic objects has attribute information on its surface. The attribute information may include information on roughness or smoothness which may be expressed by amplitude of vibration. When a user operates the interface device module 110 in a certain direction, the control module 130 moves the interface object in the certain direction on a screen displayed by the display module 170. Here, the interface device module 110 may include an input device such as four direction buttons to move the interface object up, down, to the left, and to the right, number buttons to move the interface object in certain directions, a touch screen, or a mouse. For example, when a user presses a down button among the four direction buttons, the interface object moves down by a predetermined distance on the displayed screen according to control of the control module 130.

When the interface object moves and contacts a graphic object, attribute information of the graphic object is transmitted to the drive module 150 and the attribute information is converted into a vibration signal. The vibration signal is transmitted to the interface device module 110. Then, the user can feel the vibration signal through the interface device module 110. Here, the vibration signal felt by the user is different from each other according to a motion of the interface object. In other words, interaction between the interface object and other graphic objects is different from each other according to a moving speed of the interface object. As a result, the vibration signal felt by the user is different. For example, a frequency of the vibration signal is different according to the moving speed of the interface object and attributes of a graphic object contacting the interface object.

The drive module 150 is included in the host device 120 in the embodiment illustrated in FIG. 1, but the present invention is not restricted thereto. The drive module 150 may not be included in the host device 120 but may be integrated into the interface device module 110.

FIG. 2 is a block diagram of a control module 130 included in a host device 150, according to an embodiment of the present invention.

Referring to FIG. 2, the control module 130 included in the host module 120 includes a device information processing module 132, a rendering module 134, a graphic object information processing module 136, and a graphic processing module 138.

The device information processing module 132 analyzes operation information regarding an interface object, which is received from a user through the interface device module 110, and provides an analysis result to the rendering module 134 and the graphic processing module 138. Here, the operation information is about a motion of the interface object and includes information such as a position and a speed of the interface object. The amount of the motion of the interface object may be expressed by a vibration frequency.

The graphic object information processing module 136 provides graphic screens and graphic objects including the interface object, which are stored in the storage module 190, to the graphic processing module 138 and provides attribute information on each of the graphic objects to the rendering module 134. The attribute information may include information indicating roughness or smoothness or information indicating a state of a road surface or the rise and fall of the road surface. A magnitude of such attribute included in the attribute information may be expressed using amplitude of vibration.

The graphic processing module 138 generates and outputs a graphic signal based on the information on the motion of the interface object, which is received from the device information processing module 132, and the graphic screens and the graphic objects, which are received from the graphic object information processing module 136. The graphic signal is transmitted to the display module 170 and displayed. Here, the interface object is moved corresponding to the user's operation.

The rendering module 134 generates a rendering signal based on the motion information of the interface object and the attribute information of a graphic object. The rendering signal is input to the drive module 150 to provide a haptic signal such as a vibration signal corresponding to interaction between the interface object and the graphic object. In other words, a signal to provide information needed to determine a frequency and amplitude of vibration expressing the interaction between the interface object and the graphic object is the rendering signal.

The rendering signal is input to the drive module 150. FIG. 3 illustrates the detailed structure of the drive module 150 according to an aspect of the present invention.

Referring to FIG. 3, the drive module 150 in the host device 120 includes a drive circuit module 152 and a vibration generation module 154.

The drive circuit module 152 converts the rendering signal received from the rendering module 134 into a drive signal for generating vibration. The vibration generation module 154 generates vibration based on the drive signal and transmits the vibration to the interface device module 110.

When the rendering signal can be directly used as the drive signal for driving the vibration generation module 154 generating vibration, the drive circuit module 152 may be eliminated.

The vibration generation module 154 may generate vibration using a vibration motor, a solenoid module, a piezo module, or an electroactive polymer (EAP). EAPs are polymers that have a wide range of physical and electrical properties.

Upon application of an electrical current, EAPs exhibit a considerable displacement or strain, generally called deformation. Such strain may differ depending on the length, width, thickness, or radial direction of a polymer material, and it is known that the strain is in a range of 10% to 50%, which is a very characteristic feature compared to a piezoelectric element which exhibits a strain only as high as about 3%. Therefore, it is advantageous in that the EAP can be almost completely controlled by a suitable electric system.

Since the EAP outputs an electric signal corresponding to an external physical strain applied, if any, it can be used as sensor as well. Since materials of EAP typically generate a potential difference that can be electrically measured, the EAP can be used as a sensor of force, location, speed, accelerated speed, pressure, and so on. In addition, since the EAP has a bidirectional property, it can also be used as a sensor or an actuator.

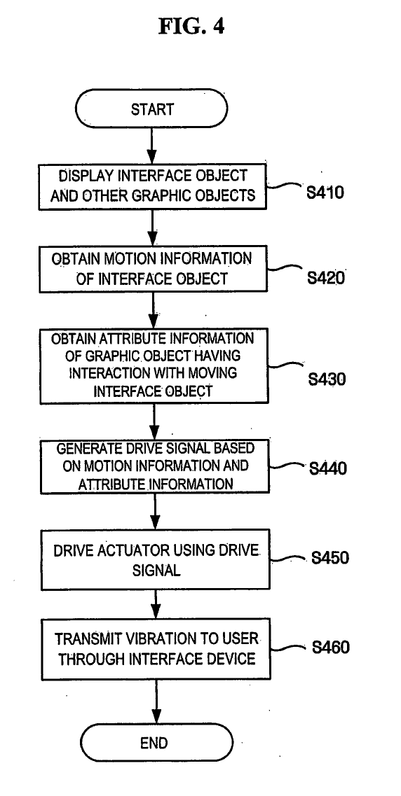

FIG. 4 is a flowchart of a user interface method according to an embodiment of the present invention.

Referring to FIG. 4, when an interface object and other graphic objects are displayed on a screen through the display module 170 in operation S410, a user moves a position of the interface object using an interface device.

In operation S420, the control module 130 obtains motion information of the moving interface object. The motion information includes information on a position and a moving speed of the interface object and also provides frequency information necessary for the generation of vibration.

Thereafter, as the interface object moves, interaction between the interface object and another graphic object occurs. In operation S430, attribute information of the graphic object having interaction with the interface object is obtained. The attribute information includes surface information of the graphic object and also provides amplitude information necessary for the generation of vibration.

The drive module 150 receives the motion information and the attribute information from the control module 130 and generates a drive signal corresponding to the information in operation S440 and generates vibration by driving an actuator using the drive signal in operation S450.

In operation S460, the vibration is transmitted to the user through the interface device so that the user can feel the interaction with the graphic object, which occurs as the interface object moves.

Meanwhile, the present invention can be used for a game device for a racing game such as Kartrider or other game devices, an interaction map, an interaction mouse, etc. Embodiments of the present invention used for those things will be described in detail below.

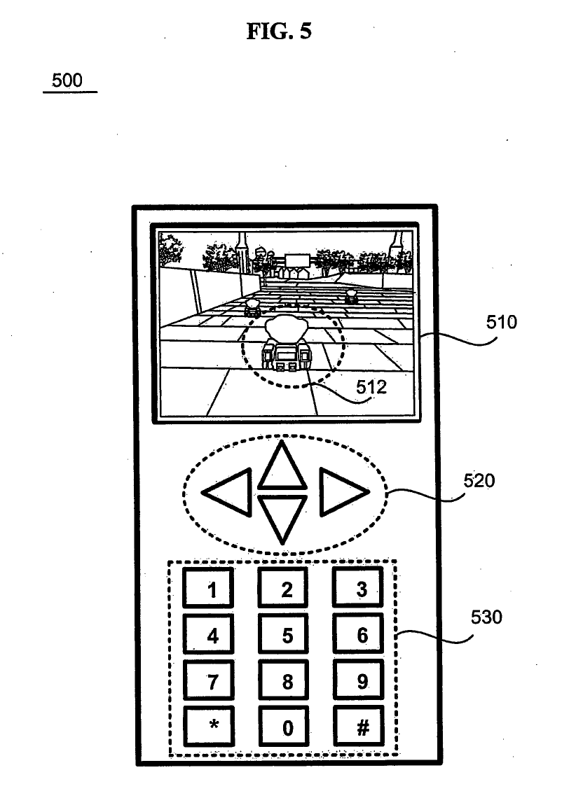

FIG. 5 illustrates a game device 500 according to an embodiment of the present invention, in which a racing game, such as Kartrider, is illustrated by way of example. The game device 500 includes a display area 510 and a user input area (520, 530).

The display area 510 displays a graphic screen on which a plurality of graphic objects appear. The plurality of graphic objects include an interface object operated by a user. In a racing game, the interface object may be a car 512 representing the user. The user input area includes input buttons used for game control and game play.

In the current embodiment of the present invention, the user input area includes a four direction button unit 520 and a number button unit 530.

Here, an input for the game control is an input for selecting game start, game end, game level, game type, or the like. An input for the game play is an input to operate a position or a speed of the interface object. For example, when a user plays a game using the four direction button unit 520 and an action button providing an action function, a left button in the four direction button unit 520 moves the car 512 to the left; a right button moves the car 512 to the right; an up button increases the speed of the car 512; and a down button decreases the speed of the car 512. The action button is used to attack another user or make the car 512 jump. The action button may be a button included in the number button unit 530.

Alternatively, when a user plays a game using the number button unit 530, number “4”, “6”, “2” and “8” buttons may provide functions corresponding to the left, right, up, and down buttons, respectively, included in the four direction button unit 520 and a number “5” button may be used to make the car 512 jump. Here, the number “5” button corresponds to the action button.

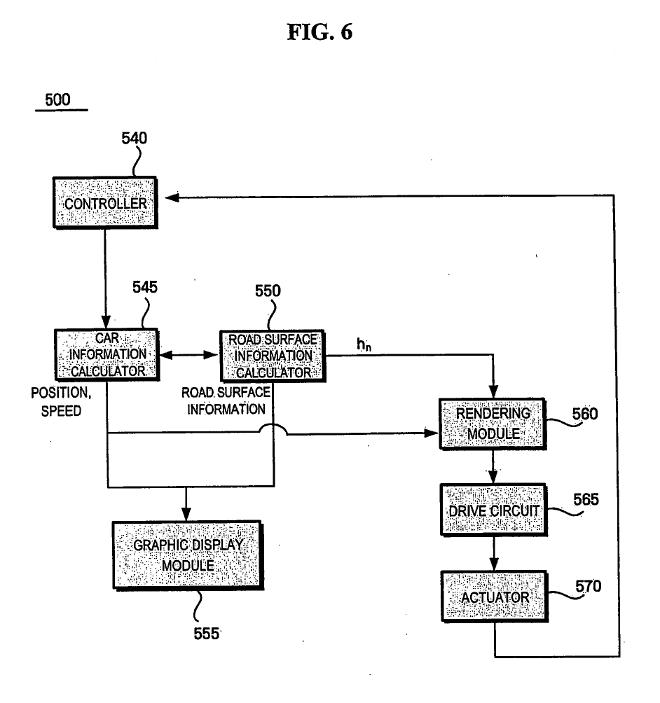

FIG. 6 is a functional block diagram illustrating the structure of the game device 500 illustrated in FIG. 5. The structure illustrated in FIG. 6 may correspond to the structure illustrated in FIG. 1, and a description will be made with reference to FIGS. 1, 5, and 6.

Referring to FIG. 6, a controller 540 corresponds to the interface device module 110 and corresponds to the four direction button unit 520 or the number button unit 530.

In addition, a set of a car information calculator 545, a road surface information calculator 550, and a rendering module 560 corresponds to the control module 130. A set of a drive circuit 565 and an actuator 570 corresponds to the drive module 150. A graphic display module 555 corresponds to the display module 170. The graphic display module 555 displays a graphic screen and graphic objects through the display area 510.

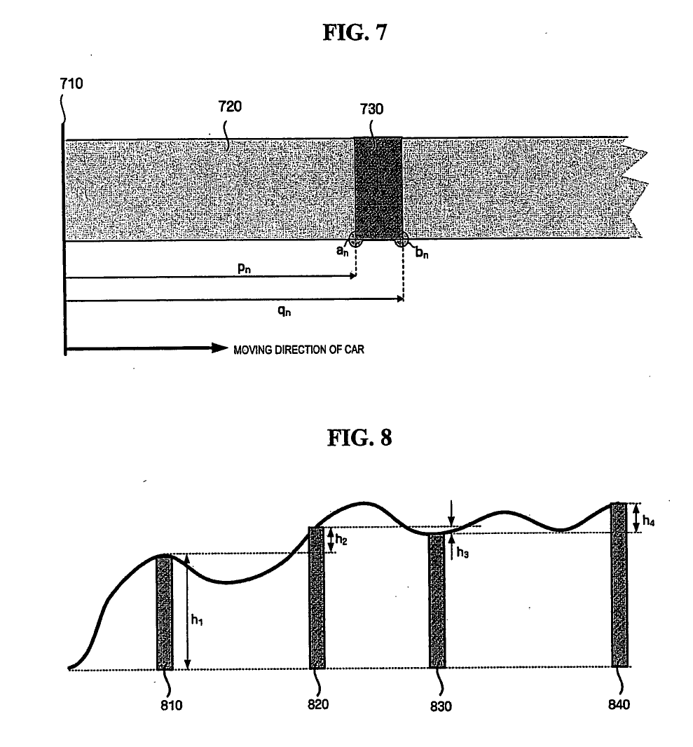

Before describing the operation of the game device 500, a game environment according to an embodiment of the present invention will be described with reference to FIGS. 7 and 8.

Referring to FIG. 7, it is assumed that a car racing track 720 extends long from a start line 710 in a moving direction of a car. The start line 710 serves as a start point or a reference point of the car racing track 720.

A dark rectangular area hatched with thick lines is located at a predetermined position on the car racing track 720 and is referred to as a virtual block 730, in which vibration is generated.

The virtual block 730 may be implemented by a single polygon or the sum of a plurality of polygons in general graphic programs and may have a predetermined area on the car racing track 720.

Accordingly, the virtual block 730 may be expressed as a part of a graphic object, i.e., the car racing track 720 or as a single graphic object separated from the car racing track 720.

Meanwhile, two points aₙ and bₙ may be defined on the virtual block 730 along the moving direction of a car. A distance from the start line 710 to the point aₙ is represented with pₙ and a distance from the start line 710 to the point bₙ is represented with qₙ.

Here, an influence of vibration generated when the car passes a section between the two points aₙ and bₙ on the car racing track 720, that is, the influence of vibration generated when the car passes an n-th virtual block can be expressed by the sum of vibration considering the delay of the distance pₙ and the delay of the distance qₙ. This influence of the vibration can be expressed by Equation (1):

$$Vib ( L ) = {h}_{n} {\sum }_{n = 1} [ u ( L - {p}_{n} ) - u ( L - {q}_{n} ) ] , \qquad ( 1 )$$

where L is a moving distance of the car from an initial start to a current time “t”. The moving distance L can be expressed by a general distance equation like Equation (2):

$$L = vt + \frac{1}{2} {at}^{2} . \qquad ( 2 )$$

Since the moving distance L may be defined based on a speed at which the car passes an (n−1)-th virtual block and acceleration at which the car passes the point aₙ, a time when the car passes a virtual block can be controlled when a user controls the speed of the car corresponding to the interface object.

In addition, in Equation (1), “hₙ” denotes information on the rise and fall of a road surface in a virtual block in a section [pₙ, qₙ] and is a parameter determining an amplitude of vibration. In other words, when a value of “hₙ” is large, a large amplitude is provided. The magnitude of amplitude will be described with reference to FIG. 8.

Referring to FIG. 8, when an “h” value of a first virtual block 810 is represented with “h₁”, an “h” value of a second virtual block 820 indicates a difference between a road surface height in the second virtual block 820 and a road surface height in the first virtual block 810 and is represented with “h₂”. In the same manner, an “h” value of a third virtual block 830 indicate a difference between a road surface height in the third virtual block 830 and a road surface height in the second virtual block 820 and is represented with “h₃”; and an “h” value of a fourth virtual block 840 indicate a difference between a road surface height in the fourth virtual block 840 and a road surface height in the third virtual block 830 and is represented with “h₄”. In other words, a value of “hₙ” in the n-th virtual block is a difference between a height of the (n−1)-th virtual block from a ground and a height of the n-th virtual block from the ground. For each virtual block, the “h” value may be predetermined and the amplitude of a vibration signal may be adjusted based on the magnitude of the “h” value.

Meanwhile, in Equation (1), Vib(L) indicates a pattern of the vibration signal and is expressed in a square wave. Alternatively, Vib(L) may be expressed in the sum of a plurality of sine waves.

When a user plays a game while controlling the speed of a car using the controller 540 in the above-described game environment, the car information calculator 545 obtains a position and a speed of the car using the moving speed and acceleration of the car. Here, the moving speed and the acceleration may be obtained by the car information calculator 545 sensing the number of times or a period of time that a speed increase or decrease button in the four direction button unit 520 or the number button unit 530 is pressed and obtaining speed or acceleration predetermined corresponding to a sensing result. The road surface information calculator 550 provides information on a road surface at a position of the moving car.

The graphic display module 555 displays a graphic screen according to the position and the speed of the car.

The rendering module 560 receives the position and the speed of the car from the car information calculator 545 and the information on the road surface from the road surface information calculator 550 and generates a rendering signal for providing a haptic signal based on the received information. Here, the position and the speed of the car is provided as frequency information used to generate a vibration signal and the information on the road surface is provided as amplitude information used to generate the vibration signal.

The drive circuit 565 generates a drive signal for driving the actuator 570 based on the rendering signal so that the actuator 570 generates the vibration signal. The drive signal includes a voltage or current signal for example.

The generated vibration signal is transmitted to the controller 540 so that the user can feel vibration. Consequently, since the frequency and the amplitude of the vibration change according to the speed of the car operated by the user and the information on the road surface, various vibration effects are provided.

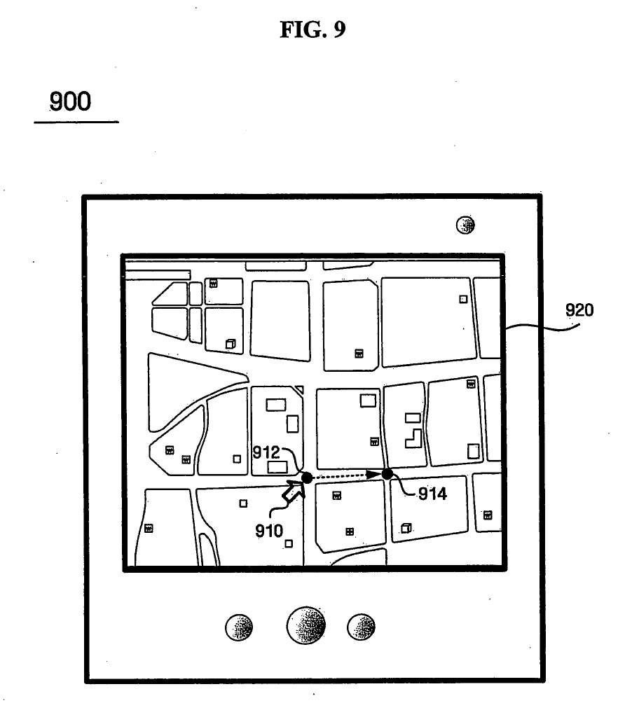

FIG. 9 illustrates a user interface system according to another embodiment of the present invention, in which a navigation system 900 is illustrated by way of example.

Referring to FIG. 9, the navigation system 900 displays a map and provides a display screen 920 including a pointer 910 pointing at a current position 912 of a user. The pointer 910 corresponds to an interface object. Here, the display screen 920 may be implemented by a touch screen.

In this case, as a touch by the user's finger moves, the pointer 910 also moves. A road on the map displayed on the display screen 920 has different road surface information. The road surface information is a parameter determining the amplitude of a vibration signal. In addition, the color of a road on the map displayed on the display screen 920 may be changed according to traffic on the road. For example, when traffic on a road is very heavy, the road may be colored in red. When the traffic is a little heavy, the road may be colored in yellow. When the traffic flows smoothly, the road is colored in blue. In this situation, it is assumed that information on the height of a road changes according to color. Here, color may be a parameter determining the amplitude of a vibration signal.

When the user moves a touch of the finger from the current position 912 to a target position 914, the frequency of a vibration signal is determined according to a moving speed. The amplitude and the frequency of the vibration signal are determined in the same manner as that used in the game device 500 according to the previous embodiment. Since the navigation system 900 uses a touch screen as an input/output interface, the user can feel vibration through the finger touching the touch screen.

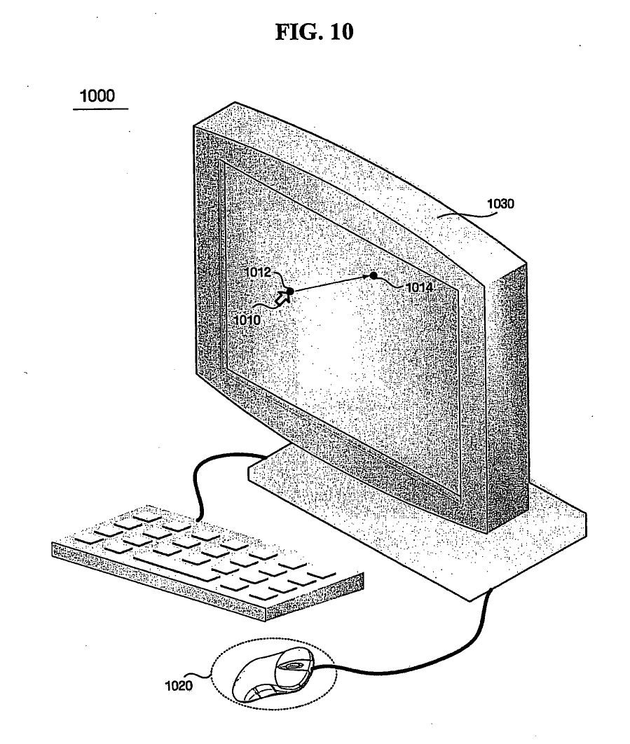

FIG. 10 illustrates a user interface system according to still another embodiment of the present invention, in which a computer system 1000 uses a mouse 1020 as an input device.

Referring to FIG. 10, a display device 1030 included in the computer system 1000 displays a pointer 1010 pointing at a current position 1012. The pointer 1010 corresponds to an interface object and changes in position and speed according to the operation of an input interface device, i.e., the mouse 1020.

In this case, a graphic screen displayed by the display device 1030 has different surface information. The surface information is a parameter determining the amplitude of a vibration signal. In addition, when a user moves the pointer 1010 from the current position 1012 to a target position 1014 using the mouse 1020, the frequency of the vibration signal is determined according to a moving speed of the pointer. The amplitude and the frequency of the vibration signal are determined in the same manner as that used in the game device 500. In the computer system 1000, the user can feel vibration through the mouse 1020. Here, the mouse 1020 may include the interface device module 110 and the drive module 150 illustrated in FIG. 1.

According to the present invention, more interactive and realistic operation feelings are provided to a user when the user operates a graphic object on a graphic screen.

While the present invention has been particularly shown and described with reference to exemplary embodiments thereof, it will be understood by those of ordinary skill in the art that various changes in form and details may be made therein without departing from the spirit and scope of the present invention as defined by the following claims. It is therefore desired that the present embodiments be considered in all respects as illustrative and not restrictive, reference being made to the appended claims rather than the foregoing description to indicate the scope of the invention.

What is claimed is:

1. A user interface system comprising:
a storage module to store a plurality of graphic objects and attribute information of each of the graphic objects;
an interface device to input a user's operation input;
a control module to receive motion information of an interface object representing a user among the plurality of graphic objects from the interface device and to provide frequency information and amplitude information based on the motion information and the attribute information; and
a drive module to generate a vibration signal based on the frequency information and the amplitude information and to transmit the vibration signal to the interface device.

2. The user interface system of claim 1, wherein the attribute information comprises information on a road surface.

3. The user interface system of claim 2, wherein the information on a road surface comprises a difference between a height of a current virtual block from a ground and a height of a previous virtual block from the ground.

4. The user interface system of claim 1, wherein the motion information comprises information on a speed at which the interface object moves.

5. The user interface system of claim 1, wherein the vibration signal is generated when the interface object is located in a virtual block of another graphic object.

6. The user interface system of claim 1, wherein the interface device comprises an input button.

7. The user interface system of claim 1, wherein the interface device comprises a touch screen.

8. The user interface system of claim 1, wherein the interface device comprises a mouse.

9. The user interface system of claim 1, wherein the drive module comprises any of a vibration motor, a solenoid module, a piezo module, and an electroactive polymer.

10. The user interface system of claim 1, further comprising a display module displaying the plurality of graphic objects.

11. The user interface system of claim 1, wherein the control module comprises
a device information processing module to analyze the operation system information or the interface object and to provide the analysis result to a rendering module;
the rendering module to generate a rendering signal based on the motion information of the interface object and the attribute information of the graphic object;
a graphic object information processing module to provide a graphic screen; and
a graphic processing module to generate a graphic signal.

12. A user interface method comprising:
receiving motion information of an interface object representing a user among a plurality of graphic objects from an interface device;
providing frequency information and amplitude information based on the motion information and attribute information of each of the graphic;
generating a vibration signal based on the frequency information and the amplitude information; and
transmitting the vibration signal to the interface device.

13. The user interface method of claim 12, wherein the attribute information comprises information on a road surface.

14. The user interface method of claim 13, wherein the information on a road surface comprises a difference between a height of a current virtual block from a ground and a height of a previous virtual block from the ground.

15. The user interface method of claim 13, wherein the motion information comprises information on a speed at which the interface object moves.

16. The user interface method of claim 13, wherein the vibration signal is generated when the interface object is located in a virtual block of another graphic object.

17. The user interface method of claim 13, wherein the interface device comprises an input button.

18. The user interface method of claim 13, wherein the interface device comprises a touch screen.

19. The user interface method of claim 13, wherein the interface device comprises a mouse.

20. The user interface method of claim 13, wherein the generating of the vibration signal comprises generating the vibration signal using any one a vibration motor, a solenoid module, a piezo module, and an electroactive polymer.

21. The user interface method of claim 13, further comprising displaying the plurality of graphic objects.

22. A user interface system comprising:
a display screen displaying a plurality of graphic objects and an interface object representing a user among the plurality of graphic objects; and
an input unit to operate a moving speed of the interface object,
wherein vibration is transmitted to the input unit according to the moving speed and/or surface information of a graphic object interacting with the interface object.

23. The user interface system of claim 22, wherein a predetermined block is formed on each of the graphic objects and the vibration is transmitted to the input unit when the interface object is located in the predetermined block.

24. A user interface system comprising:
a storage module to store a plurality of graphic objects and attribute information of each of the graphic objects;
an interface device to input a user's operation input;
a control module to receive motion information of an interface object moved by a user among the plurality of graphic objects from the interface device and to provide frequency information and amplitude information based on the motion information and the attribute information; and
a drive module to generate a vibration signal based on the frequency information and the amplitude information and to transmit the vibration signal to the interface device.
